(19) United States
(12) Patent Application Publication
(10) Pub. No.: US 2011/0119169 A1
(43) Pub. Date: May 19, 2011

(54) Computer-Based System and Method for Automating the Settlement of Debts

(76) Inventors: Anthony Passero, Fort Lauderdale, FL (US); Kevin Ellis, Pembroke Pines, FL (US); Efrain Antonio Garcia Poveda, Coral Springs, FL (US)

(21) Appl. No.: 12/945,841

(22) Filed: Nov. 13, 2010

Related U.S. Application Data
(60) Provisional application No. 61/261,048, filed on Nov. 13, 2009.

(51) Int. Cl. G06Q 40/00

(52) U.S. Cl. 705/35

(57) ABSTRACT

The present invention is a method and system for facilitating a settlement negotiation of a debt between a debtor and a creditor whereby settlement proposals are automatically and intelligently generated, based upon the financial circumstances of the debtor and a pattern of decision-making behavior of the creditor, and are sent throughout the duration of the negotiation process until an acceptable proposal is secured. Furthermore, the present invention also provides an automatic, streamlined framework for the user or client to budget for and carry through with payment of the debt in accordance with the agreed upon settlement. This negotiation and settlement process occurs without any direct contact between the debtor and the creditor, or an outside intermediary, by automating a significant part of the negotiation and repayment process whereby the process is transparent and visible to the debtor and creditor.

### CROSS-REFERENCE TO RELATED APPLICATION

This application claims the priority, under 35 U.S.C. §119, of U.S. Provisional Patent Application Ser. No. 61/261,048, filed Nov. 13, 2009, the entire disclosure of which is hereby incorporated herein by reference in its entirety.

### FIELD OF THE INVENTION

The present invention relates in general to a system and method for automating the settlement of unsecured debts and, more specifically, to a computer-based system and method for arbitrating the negotiation process of settling a debtor's outstanding debt in a fully automated manner such that the line of communication between the debtor and the creditor is indirect and yet viewable to both the debtor and the creditor.

### BACKGROUND OF THE INVENTION

It is well-established that the majority of the world's economy is based upon a system of credit and, currently, there are a significant number of people and other types of entities (governmental and private) who are in debt or base their operations largely upon the availability of credit. A significant percentage of debts are in the form of unsecured debts, which are usually substantially more difficult to collect in comparison to secured debts. Generally speaking, the creditor is typically the more dominant party in the debtor/creditor relationship and is oftentimes unwilling to go through a process of negotiating the settlement of a debt, especially where a debtor is difficult to track down. For a debtor, the experience of having a debt being collected from them is very stressful and oftentimes, is felt as a form of harassment. Therefore, it would be desirable to provide a negotiating or arbitrating platform that achieves a semblance of equality between the debtor and the creditor and provides flexibility, and yet some assurance, in the collection and repayment of debts. Additionally, it would be desirable that the platform be user-friendly and fully automated in order to relieve the debtor and creditor of a direct line of communication and having to expend significant resources and energy in achieving a settlement of the debt.

Thus, a need exists to overcome the problems discussed above.

### SUMMARY OF THE INVENTION

The system and method of the present invention provides a unique way of automating the settlement of unsecured debts. Traditionally, debt settlement has been a negotiation process whereby a debtor seeks to settle a debt at a lower amount than the owed balance. These negotiations are often performed by third parties and rarely do a creditor and debtor interact directly. Without diligent research, it can be difficult for a debtor to directly propose an acceptable offer to a creditor without the need for a third party. A certain amount of back and forth negotiations is inevitable until an agreed upon resolution is found. The present invention seeks to streamline the debt settlement process by placing the negotiation power into a debtor's hands through a “Software as a Service” (SOA) platform.

The invention incorporates a computer-based software application that may be used by a debtor to fully automate the negotiation over the repayment of one or more outstanding debts owed to one or more creditors. By executing a user agreement or contract, the debtor is given secured access to the system and all of the necessary information relating to a debtor's outstanding debts and the identity of the debtor's creditors is transferred into the system. Once the information is transferred, the system immediately initiates contact with the debtor's creditors on behalf of the debtor. For example, a cease and desist letter regarding the collection of the debt and a settlement proposal, which has been automatically generated using one or more predetermined algorithms, is sent to the creditor in an attempt to come to an agreement to settle the outstanding balance that is owed by the debtor.

To respond to the settlement proposal, the creditor is also given secured access to the system so that the creditor may view, accept, decline, or submit a counteroffer to the settlement proposal. Should the creditor decline a proposal or present a counteroffer, the system will automatically generate a new proposal that will be sent to the creditor in order to proceed with the negotiation process. Upon acceptance of a settlement proposal, funds that have been accumulated in a debtor's “savings” account will be immediately sent to the creditor to satisfy the outstanding debt per the terms of the accepted settlement proposal. This entire negotiation process is made fully visible to both the debtor and the creditor by the system and method of the present invention.

With the foregoing and other objects in view, there is provided, in accordance with the invention, a system for facilitating a settlement negotiation of a debt between a debtor and a creditor, including at least one database operable to store user-entered data figures that reflect information about at least one account of which the debtor is in debt, a computerized portal directly accessible to at least one debtor through a debtor user-interface, directly accessible to at least one creditor through a creditor user-interface, and being in communication with the at least one database to permit data entry by the debtor of the data figures through the debtor user-interface and storage of the data figures into the at least one database, a computer system in communicative contact with the at least one database and the portal and programmed to generate a score associated with the at least one account and dependent upon the data figures, the score being a criterion to determine if the at least one account is eligible for settlement, to automatically generate an initial settlement offer based at least in part upon the data figures, if the at least one account is eligible for settlement, and to automatically relay the initial settlement offer to the respective creditor of the at least one account, permit the creditor to access the initial settlement offer, through the creditor user-interface, and directly act upon the initial settlement offer, store in the at least one database action information corresponding to action taken by the creditor on the initial settlement offer, and make the action information directly visible to the debtor when the debtor subsequently accesses the action information through debtor user-interface.

In accordance with another feature of the invention, access to the portal requires a secure password.

In accordance with a further feature of the invention, the data figures reflect information selected from at least a balance owed by the debtor on the at least one account, a date on which the account was past due, an identity of the respective creditor of the account, and an amount of the debtor's income.

In accordance with an added feature of the invention, the computer system is programmed to automatically generate the score after the user-entered data figures are stored in the at least one database.

In accordance with an additional feature of the invention, the at least one database is operable to store a creditor behavior profile of the at least one creditor and the computer system is programmed to generate the creditor behavior profile dependent upon each action taken by the creditor in response to at least the initial settlement offer.

In accordance with yet another feature of the invention, the computer system is programmed to carry out a debtor-to-creditor communication process that exchanges at least one additional settlement offer after the initial settlement offer, to alter the creditor behavior profile dependent upon each action taken by the creditor in response to at least the initial settlement offer and the at least one additional settlement offer, and to predict an action the creditor will likely take on at least one of at least the initial settlement offer and the at least one additional settlement offer based upon each action taken by the creditor in response to a settlement offer that is similar to at least one of the initial settlement offer and the at least one additional settlement offer.

In accordance with yet a further feature of the invention, the creditor behavior profile is automatically updated each time the creditor takes an action in response to at least one of the initial settlement offer and the at least one additional settlement offer.

In accordance with yet an added feature of the invention, the computer system is programmed to base the initial settlement offer at least in part upon the prediction from the creditor behavior profile.

In accordance with yet an additional feature of the invention, the action taken by the creditor is selected from an acceptance of the initial settlement offer, a rejection of the initial settlement offer, and/or a counter settlement offer to the initial settlement offer.

In accordance with again another feature of the invention, the computer system is programmed to automatically generate a new settlement offer and relay the new settlement offer to the creditor if the creditor rejects the initial settlement offer.

In accordance with again a further feature of the invention, the at least one database is operable to store a user-entered debtor profile comprised of profile information entered by the debtor through the debtor user-interface, the profile information reflecting a financial condition of the debtor and including a range of possible settlement offers based at least in part on the information reflecting the financial condition of the debtor and to store a creditor behavior profile comprised of each past action taken by the creditor in response to at least one of the initial settlement offer and the at least one additional settlement offer, and the computer system is programmed to predict what action the creditor will likely take on any given settlement offer based upon each past action taken by the creditor in response to at least one of the initial settlement offer and the at least one additional settlement offer similar to the given settlement offer, the new settlement offer being within the range of possible settlement offers in the debtor profile and dependent at least in part upon at least one of the prediction and the creditor behavior profile.

In accordance with again an added feature of the invention, upon receipt of a counter settlement offer, the computer system is programmed to provide the debtor with a choice selected from accept the counter settlement offer of the creditor, reject the counter settlement offer of the creditor, and/or counter the counter settlement offer of the creditor.

In accordance with again an additional feature of the invention, the computer system is programmed to permit direct debtor access to the choice of accepting, rejecting, or countering the counter settlement offer, to store in the at least one database the choice of the debtor, and to visibly display the choice to the creditor through the creditor user-interface upon subsequent creditor access of the portal.

In accordance with still another feature of the invention, the at least one database is operable to store a user-entered debtor profile comprised of profile information entered by the debtor through the debtor user-interface, the profile information reflecting a financial condition of the debtor and including a range of possible settlement offers based at least in part on the information reflecting the financial condition of the debtor and to store a creditor behavior profile comprised of each action taken by the creditor in response to at least one of the initial settlement offer and the at least one additional settlement offer, and the computer system is programmed to one of accept, reject, and counter the creditor's counter settlement offer on behalf of the debtor based at least in part on whether or not the counter settlement offer of the creditor is within the range of possible settlement offers.

With the objects of the invention in view, there is also provided a method for facilitating a settlement negotiation of a debt, including the steps of directly accessing a computerized portal by at least one debtor using a user-interface, the portal being in communication with at least one database; inputting into the portal data figures that reflect information about at least one account of which the at least one debtor is in debt, storing the data figures in the at least one database, analyzing the data figures to give the at least one account a score, and determining if the at least one account is eligible for settlement using the score as a criterion and, if the account is eligible for settlement automatically generating an initial settlement offer based at least in part upon the data figures; automatically relaying the initial settlement offer to a respective creditor of the at least one account, acting upon the initial settlement offer by directly accessing the portal by the creditor using the user-interface, storing the action of the creditor in the at least one database, and making the creditor's action directly visible to the debtor upon subsequent debtor access of the portal.

In accordance with another mode of the invention, access to the portal requires a secure password.

In accordance with a further mode of the invention, the data figures reflect at least the balance owed by the debtor on the at least one account, the date on which the account was past due, the identity of the respective creditor of the account, and the amount of the debtor's income.

In accordance with an added mode of the invention, the analyzing step to generate the score is carried out automatically after the data figures are stored in the at least one database.

In accordance with an additional mode of the invention, there are provided the steps of storing a creditor behavior profile in the at least one database, the creditor behavior profile being comprised of each past action taken by the creditor in response to a settlement offer and utilizing the creditor behavior profile, predicting what action the creditor will likely take on any given settlement offer based upon each past action taken by the creditor in response to a settlement offer that was similar to the given settlement offer.

In accordance with yet another mode of the invention, there is provided the step of automatically updating the creditor behavior profile each time the creditor takes an action in response to a settlement offer.

In accordance with yet a further mode of the invention, the initial settlement offer is based, at least in part, upon the prediction from the creditor behavior profile.

In accordance with yet an added mode of the invention, the action of the creditor is an acceptance of the initial settlement offer, a rejection of the initial settlement offer, or a counter settlement offer to the initial settlement offer.

In accordance with yet an additional mode of the invention, there is provided the step of automatically generating and relaying to the creditor a new settlement offer if the creditor rejects the initial settlement offer.

In accordance with again another mode of the invention, there are provided the steps of storing a debtor profile in the at least one database, the debtor profile being comprised of information, entered into the portal by the debtor and stored in the at least one database, that reflects the financial condition of the debtor and utilizing the debtor profile to provide a range of possible settlement offers based at least in part on the information reflecting the financial condition of the debtor, storing a creditor behavior profile in the at least one database, the creditor behavior profile being comprised of each past action taken by the creditor in response to a settlement offer, utilizing the creditor behavior profile to predict what action the creditor will likely take on any given settlement offer based upon each past action taken by the creditor in response to a settlement offer that was similar to the given settlement offer, generating the new settlement offer from the range of possible settlement offers, and basing the new settlement offer, at least in part, upon the prediction from the creditor behavior profile.

In accordance with again a further mode of the invention, if the creditor counters the initial settlement offer, the debtor carries out accepting the creditor's counter settlement offer, rejecting the creditor's counter settlement offer, or countering the creditor's counter settlement offer.

In accordance with again an added mode of the invention, there is provided the step of directly accessing the portal by the debtor using the user-interface to take a debtor's action selected from one of accepting, rejecting, and countering the creditor's counter settlement offer and storing the debtor's action in the at least one database, the debtor's action being directly visible to the creditor upon the creditor subsequent access of the portal.

In accordance with a concomitant mode of the invention, there are provided the steps of storing a debtor profile in the at least one database, the debtor profile being comprised of information, entered into the portal by the debtor and stored in the at least one database, that reflects the financial condition of the debtor, utilizing the debtor profile to provide a range of possible settlement offers based at least in part on the information reflecting the financial condition of the debtor, and one of accepting, rejecting, and countering the counter settlement offer of the creditor based, at least in part, on whether or not the counter settlement offer of the creditor is within the range of possible settlement offers.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Although the invention is illustrated and described herein as embodied in one or more exemplary embodiments, it is, nevertheless, not intended to be limited to the details shown because various modifications and structural changes may be made therein without departing from the spirit of the invention and the scope and range of equivalents of the claims. Additionally, well-known elements of exemplary embodiments of the invention will not be described in detail or will be omitted so as not to obscure the relevant details of the invention.

The construction and method of operation of the invention, however, together with additional objects and advantages thereof, will be best understood from the following description of specific embodiments when read in connection with the accompanying figures.

Other features that are considered as characteristic for the invention are set forth in the appended claims.

### BRIEF DESCRIPTION OF THE DRAWINGS

The accompanying figures, where like reference numerals refer to identical or functionally similar elements and which, together with the detailed description below, is incorporated in and forms part of the specification, serves to further illustrate various embodiments and to explain various principles and advantages all in accordance with the present invention. Advantages of embodiments of the present invention will be apparent from the following detailed description of the preferred embodiments thereof, which description should be considered in conjunction with the accompanying drawings in which:

FIG. 1 is a process flow diagram illustrating the system and method for automating the settlement of a user's debts according to an exemplary embodiment of the present invention.

FIG. 2 is a process flow diagram illustrating an initial enrollment process for a user or client according to an exemplary embodiment of the system and method of the present invention.

FIG. 3 is a process flow diagram illustrating a process for scoring a user's account, according to an exemplary embodiment of the present invention.

FIG. 4 is a process flow diagram illustrating a workflow where a particular debt settlement proposal is automatically generated for an account that has been deemed eligible for settlement according to an exemplary embodiment of the present invention.

FIG. 5 is a block diagram illustrating a creditor's view of the portal of the system and method of the present invention according to an exemplary embodiment of the present invention.

FIG. 6 is a process flow diagram illustrating a method for disbursing settlement funds upon agreement of a settlement offer according to an exemplary embodiment of the present invention.

FIG. 7 is a block diagram illustrating a process for disbursing settlement funds upon agreement of a settlement offer according to an exemplary embodiment of the present invention.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for any claims and as a representative basis for teaching one skilled in the art to variously employ the present invention in virtually any appropriately detailed structure. Further, the terms and phrases used herein are not intended to be limiting; but rather, to provide an understandable description of the invention. While the specification may conclude with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

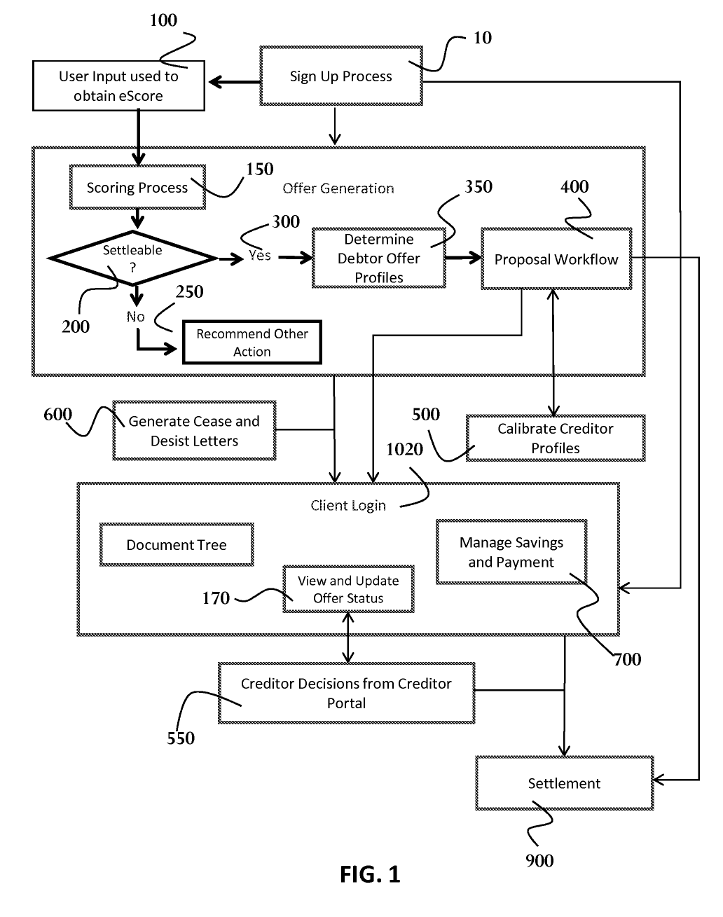

Described now is an exemplary embodiment of the present invention. Referring now to FIG. 1 of the drawings in detail, there is shown, according to an exemplary embodiment of the present invention, a flow diagram of the computer-based, automated system and method whereby each user or “client” can access and be able to use the system and method of the present invention using a computer software application. Each user or client can access the software application using any device that is capable of executing the software application, such as a personal computer or PC. The software application is comprised of a user-friendly interface that is in communication with one or more networks and one or more databases using a wired or wireless connection between the software-executing device and the one or more networks and the one or more databases.

Users of the present invention include, but are not limited to, debtors who may be individuals or other types of entities, and any type of creditor, including, but not limited to government or private sector lenders. The system and method of the present invention is applicable to all types of industries where loans or credit is extended and unsecured debts are incurred.

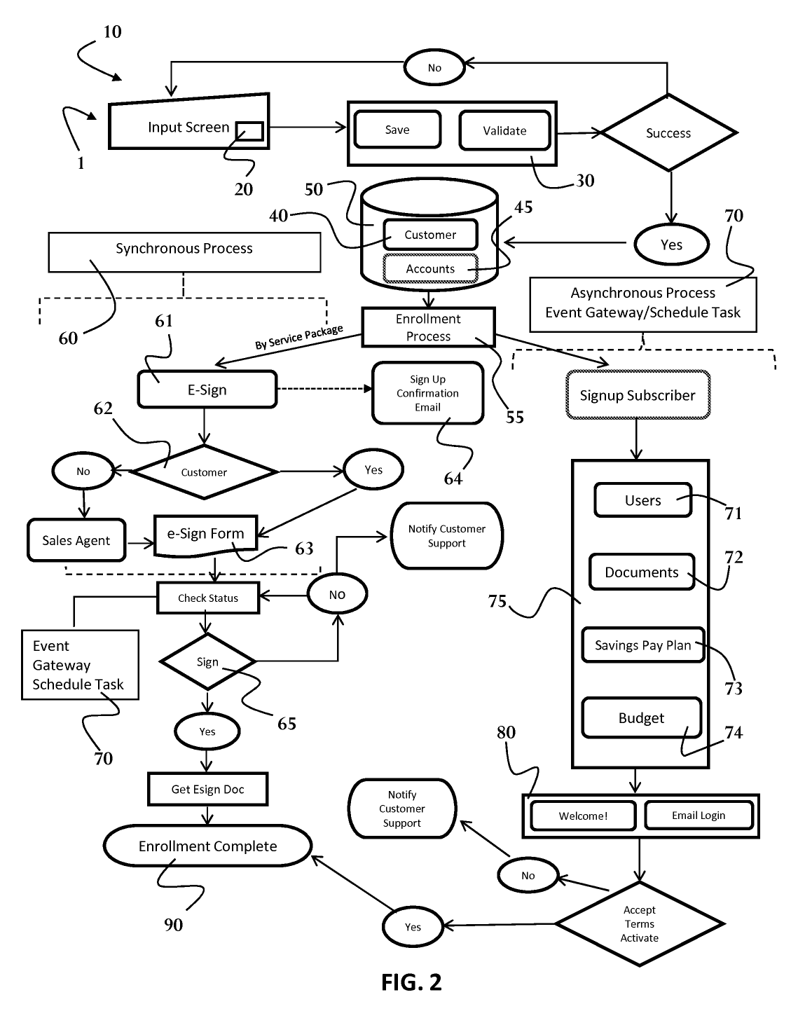

As shown in FIG. 2, to access and begin use of the system and method of the present invention, a user or client must initially enroll or go through a sign up process 10 using the software application. It is envisioned that the user or client be required to enter into a user agreement or contract (for example, an end-user license agreement or contract) to gain access to the secured system and method of the present invention. With the execution of the user agreement or contract, the user's or client's necessary financial and personal information is automatically transferred or entered into the system. For example, if the user or client is a debtor, this information necessarily would include information pertaining to their debt, income, and personal identification. Such information would include, for example, the identity of the user or client's one or more creditors, a current assessment of the user or client's payment status or account balances, banking information, etc.

This process 10 begins with a user or client entering 20 into the system the necessary financial and personal information by entering the data into input fields, for example, on a sign-up form displayed by a user-interface of a computerized portal 1 of the system. This sign-up form will capture the data and will be utilized by other parts of the system. Once entered, the user or client's data is stored 30 and becomes a customer record 50. At least one, or a plurality, of accounts of which the user or client is in debt is stored as an accounts record 45, each record having an associated user identifier 40. For example, if the user or client enters information pertaining to four different credit card accounts on which the user or client is in debt, then the customer record will know that this person has four accounts and there will be four account records that will be identified with the client's user identifier.

Following the user or client's data input and the creation of the customer record 50, two parallel processes occur to complete the enrollment process 55. In a synchronous process 60, the user or client is required to execute 65 a user agreement or contract 61 in, for example, an electronic form (“e-Sign”) 63, that is populated 62 by the data input 20 provided by the user or client in the initial sign-up form.

Thereafter, a confirmation or acknowledgment communication 64, including a security identification code and password for gaining future access 1020 to the system, is automatically generated and sent to the user or client by electronic mail, physical mail, or by other methods. Using this identification code and password, the user or client can access the system and view all activity occurring with respect to the repayment of the user or client's debts to the one or more creditors. Furthermore, a user or client may conveniently make changes to their account. For example, a user or client may change the payment date, update any banking information, or add or enroll one or more creditors to the user or client's account in the system.

In an asynchronous process 70 occurring in parallel with the synchronous process 60 described above, a plurality of records 75 are created that serve as the data layer for a particular user or client's system account.

Once the user or client receives the confirmation or acknowledgment communication 64 enclosing the user or client's credentials for accessing the system, the user or client must access 80 the system for a first time in order to complete the enrollment 90 and to view and receive a series of documents 72, a savings and payment plan 73, a budget 74, and a user profile 71 that are created during the asynchronous process 70. Each of these features is described in greater detail below. In general, the series of documents 72 may include, for example, any cease and desist letters and settlement offer letters that have been automatically generated based upon the account and creditor information entered into the system by the user or client. The savings and payment plan 73 and the budget 74 are also automatically generated by the system based upon the account and financial information entered into the system by the user or client. The savings and payment plan 73 is a suggested strategy for the user or client to set aside and deposit funds in an escrow account, the funds are in the escrow account then being dedicated to, for example, paying a lump sum settlement of a debt when the escrow account reaches the necessary amount. The budget 74 is a component of the savings and payment plan. The budget 74 provides the user or client with certain recommended budgeting constraints given the user or client's income and other financial parameters. The user profile 71 is a part of the customer record 50. The user or client has information relating to their personal identification and a particular number that is associated with the user agreement or contract 61. The user profile can be used, in conjunction with the contract 61, to identify the correct user or client for login into the system's user interface.

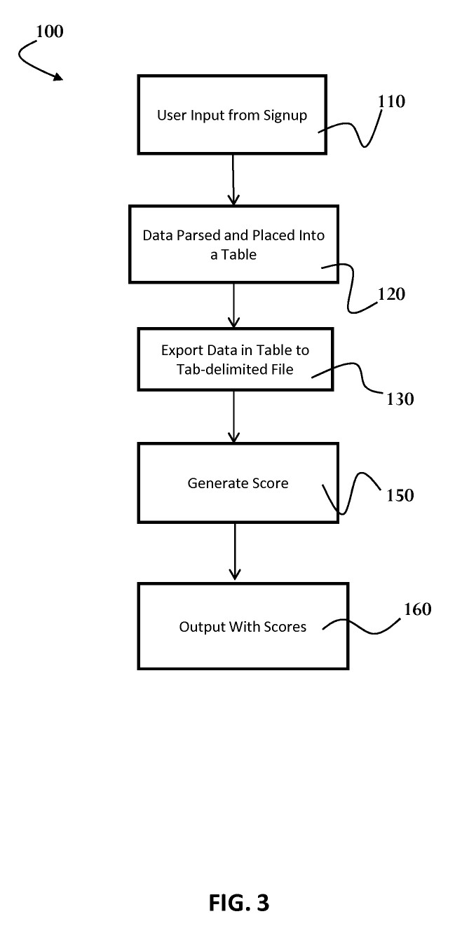

Once all of the user or client's necessary financial and personal information is transferred into the system, a scoring process 100 begins as shown, for example, in FIG. 3. The scoring process may be executed automatically by the system. Using the information input by the user or client, the system automatically generates a score 150 for each of the user or client's individual accounts, the score 150 being used as a criterion for ranking an account or determining whether or not the account is eligible for settlement. The user or client's information may be extracted 110 from the customer record 50 and the one or more account records 45 and can include, but is not limited to, the user or client's account number, social security number, contact information, date of birth, account balance, and account debt type code. Information about the user's account can also be extracted and may include, but is not limited to, the last payment date, credit limit, and origination date. The extracted data is then parsed and formatted into, for example, an input table 120. Once the fields of the input table are populated, the data is exported and formatted 130 into a tab-delimited file. Thereafter, the system performs its analysis, using a proprietary scoring mechanism, and generates the score 150. A similar tab-delimited file is outputted 160 and includes the score for each of the user or client's accounts.

Once the account's score is returned, the system uses the score as a factor in determining 200 whether or not an account is eligible for settlement (see FIG. 1). For example, if the score 150 falls below a certain pre-determined benchmark or threshold, the account may be deemed ineligible for settlement. As explained in further detail below, if an account is deemed to be eligible for settlement 300, the score will be used to automatically create 350 a range of settlement offers, in what may be referred to as a “Debtor Offer Profile,” that will be presented to the creditor of the account. This profile will provide the initial settlement offer amounts for each account. If it is deemed that an account cannot be settled, then another action will be recommended 250 to the user or client, such as entering into bankruptcy or payment of the entire debt in full.

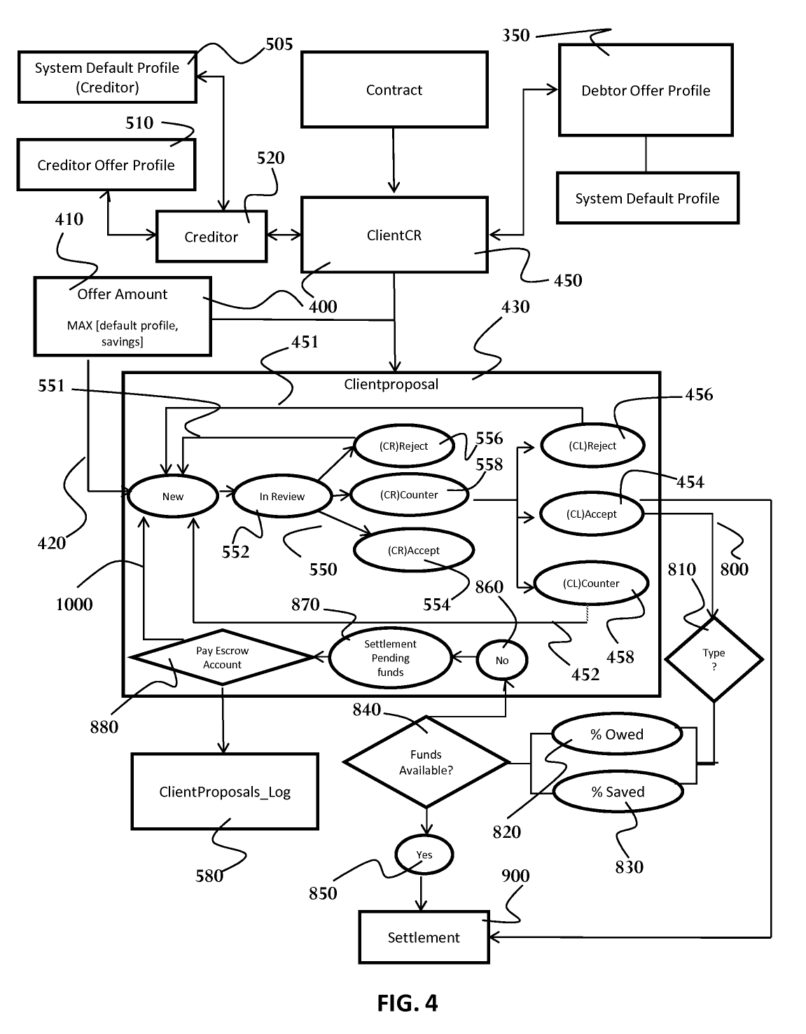

Depicted in FIG. 4 is a workflow process 400, according to an exemplary embodiment of the present invention in which a particular debt settlement proposal is automatically generated for an account that has been deemed eligible for settlement. Based upon the user or client's financial and personal information gathered by the system as described above, one or more settlement proposals are automatically generated from the user or client's creditor record, (or “ClientCR”) 450, using one or more pre-determined algorithms. With an initial offer amount determined 410, the system immediately initiates contact with the one or more creditors on the account in furtherance of negotiating the settlement of the outstanding debt. This settlement proposal is automatically sent 420 to the creditor using, for example, electronic correspondence (e.g., by e-mail or e-fax) or by other methods on behalf of the user or client in an attempt to come to an agreement to settle the outstanding balance that is owed by the user or client for that account enrolled in the system.

Referring back to FIGS. 1 and 2, in a parallel process to the generation of settlement offers or proposals 400, a savings payment plan and budget 73, 74 may be automatically generated 700 based upon the offer amounts proposed in the settlement proposals. Upon accessing the system 1020, the user or client is able to view these documents and savings payment plan, and update their offer status or change offers if the automatically determined initial offer amount is not within their preference. Specifically, by accessing the user or client's account on the system, the user or client may view all documents that have automatically been sent to the one or more creditors. As mentioned above, the savings and payment plan 73 and budget 74 are automatically generated based upon the account and financial information that was entered into the system by the user or client and in conjunction with the settlement proposals or offers that are generated and relayed to a creditor. The savings and payment plan 73 and budget 74 provide a recommended framework that a user or client should follow in order to successfully meet the payment requirements of the settlement proposal or offer being presented to the creditor in view of the user or client's income and other financial considerations. For example, the savings and payment plan 73 and budget 74 may set forth a certain amount of funds that must be set aside and deposited in a specified “savings” or a dedicated escrow account by the user or client on a periodic (e.g., monthly, bi-weekly) basis in order to make the payments in line with the particular schedule or timeframe that is required by the settlement proposal or offer.

Referring back to FIG. 4, the settlement proposal may evolve 430 through different states based upon any back-and-forth negotiations and the resulting decisions made by the one or more creditors (“CR”) and the debtor (“CL”). As this negotiation process is carried out, the system of the present invention intelligently “learns” and records the behavior of the one or more creditors and the associated accounts in order to calibrate 500, from a default profile, a profile that is characteristic of the creditor, which may be referred to as a “Creditor Offer Profile” 510. The “Creditor Offer Profile” 510 sets forth a predictable settlement range, based on the past and learned behavior of the creditor, for accounts that are defined by certain characteristics. These characteristics may include, but are not limited to, the account's balance, days past due, original enrollment date, credit limit, and score 150. Thus, the “Creditor Offer Profile” will contain the parameters for which a particular creditor is most likely to accept a settlement offer for a given type of account with an associated score 150. Accordingly, prior to sending 420 a settlement offer to a creditor, the client's creditor record (“ClientCR”) 450 performs a conditional check to determine whether or not the automatically generated initial offer amount 410 is amenable to the “Debtor Offer Profile” 350, the “Creditor Offer Profile” 510, and the current dollar amount held in “savings” or in the dedicated escrow account by the user or client.

In a separate process from the generation of settlement offers or proposals 400, cease and desist letters are generated 600 from the information extracted from the user or client's original sign-up form 10 and sent to each of the creditors of the overdue accounts enrolled in the system by the user or client. The cease and desist letters seek the delay of the collection of the debt and are automatically sent to the creditors using electronic correspondence (e.g., by e-mail or e-fax) or by other methods on behalf of the user or client.

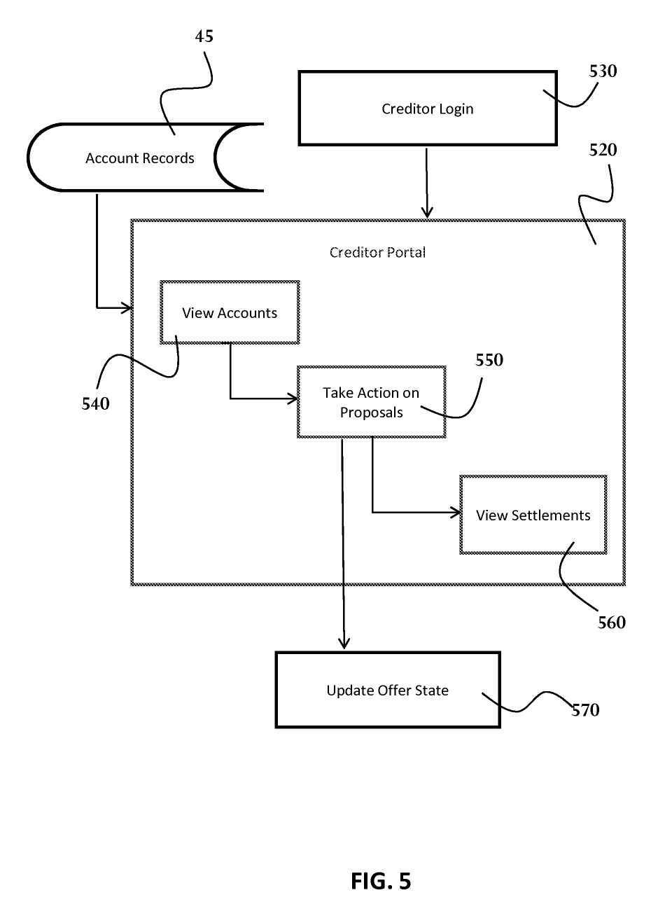

Referring now to FIGS. 4 and 5, in order for the creditor to respond 550 to the settlement proposal, a security identification code and password is also relayed 530 to the creditor so that the creditor may gain access to the secured system and method of the present invention through a separate creditor interface or portal 520. Upon access to the system, the creditor can view 552, accept 554, decline 556 or present a counteroffer 558 to any settlement proposal it has received from the system. The account records 45 will be imported into a given creditor's portal 520 and sorted by a creditor identifier. Should a creditor decline 556 a settlement proposal, the system will automatically generate a new settlement proposal 551 of the user or client's debt based upon one or more predetermined algorithms whereby the new settlement proposal 551 will fall within the range of settlement offers provided by the “Debtor Offer Profile” 350. This new proposal is sent to the creditor in order to proceed with the negotiation process. Once the creditor takes an action or makes a decision on a settlement offer or proposal, the state of that particular offer or proposal is updated or changed 570 to reflect the creditor's action or decision and is simultaneously visible to the user or client. The user or client can view all settlement proposals that have been accepted, declined, or countered by a creditor (shown as 170 in FIG. 1).

As a creditor reviews 552 open settlement offers and takes resulting actions 550, the “Creditor Offer Profile” 510 will be automatically updated 500 to reflect a present state of knowledge about the creditor's behavior and tendencies in taking certain actions on certain types of settlement offers. For example, if a certain type of settlement offer had previously been within the acceptable range of a creditor's “Creditor Offer Profile” 510, but since that time, a similar settlement offer has been subsequently rejected by the creditor, the “Creditor Offer Profile” will be updated to reflect this change. In this way, the “Creditor Offer Profile” allows the process to intelligently and uniquely identify and craft settlement proposals that are more likely to be accepted by the creditor in comparison to a benchmark settlement offer.

Should the creditor submit a counteroffer 558, the user or client must determine whether or not to accept 454, reject 456, or submit a counteroffer 458 to the creditor. If the user or client decides to reject or submit a counteroffer, the system automatically generates a new settlement proposal 451, 452 for the creditor's review 552. Once the user or client takes an action or makes a decision on a settlement offer or proposal, the state of that particular offer or proposal is updated or changed to reflect the user or client's action or decision and is simultaneously visible to the creditor.

Accordingly, the system and method of the present invention acts as the user or client's “arbitrator” by having settlement proposals automatically generated and sent throughout the duration of the process of collecting the funds or as requested by the user or client. Furthermore, the present invention does not only bring about a settlement proposal acceptable to both the user or client and the creditor(s), but also provides an automatic, streamlined framework for the user or client to carry through with payment of the debt in accordance with the agreed upon settlement. Therefore, the present invention allows a user or client to control their savings and thus, the payment plan for the settling of their debt.

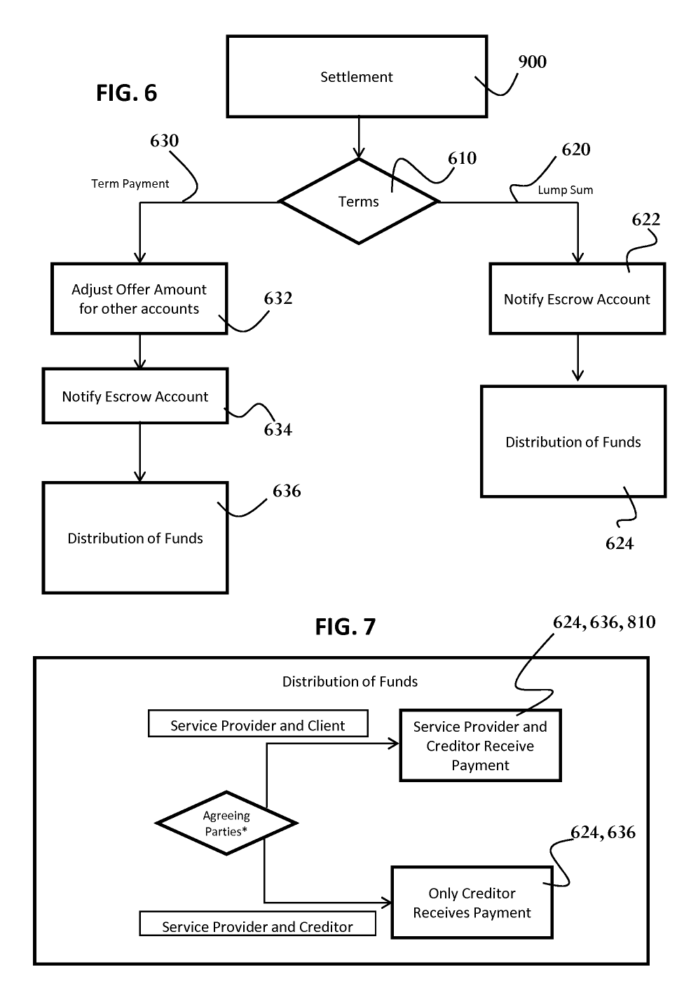

Specifically, upon a creditor accepting 554 a settlement proposal, the funds that have accumulated in a “savings” or dedicated escrow account of the user or client will automatically be sent to the creditor to satisfy the outstanding debt. The available funds in the “savings” or escrow account are accumulated in such a way that a percentage of all payments being made by the user or client is automatically placed into this account resulting in the accumulation of funds over time. The user or client will have access to view this process as it occurs. Once the one or more payments are made and the debt is satisfied in full, the automated process and the settlement is complete 900. FIGS. 6 and 7 depict an exemplary process for dispersing the accumulated funds in accordance with the terms 610 of the agreed-upon settlement 900. For example, the terms 610 of the settlement may require that the user or client pay the settlement amount in a lump sum 620 or, alternatively, may require that the user or client pay a term sum 630. In the event of a lump sum payment 620, the escrow account is notified 622 to disburse the funds 624 to the appropriate entity. In the event of a term sum payment 630, it may be necessary to first adjust 632 the offer amounts on the user or client's other enrolled accounts due to the ongoing nature of the term payments. After this adjustment is made, the escrow account is notified 634 to disburse the funds 636 to the appropriate entity.

Referring back to FIG. 4, in order to fund the service provided by the system and method of the present invention, the settlement 900 may be made contingent on payment of a service fee to a service provider of the system and method of the present invention. The type of fee 810 may be determined 800 once a settlement offer is agreed upon by both the user or client and the creditor(s). The type of fee accessed may be, for example, based on a percentage of the debt amount of the settled account 820, or of the amount of funds saved by the settlement of the account 830. Once the fee is determined, the system determines 840 whether or not a sufficient amount of funds for payment of the fee exists in the user or client's particular “savings” or escrow account. If there are sufficient funds available 850 for payment of the fee, then the settlement can be completed 900. If there are not sufficient funds available 860 for payment of the fee, a new status, such as a “Settlement Pending Funds” state 870, may occur until the necessary funds are deposited 880 into the escrow account. Consequently, the entire settlement process will reset 1000 and begin anew if the necessary funds are not deposited in the escrow account within an agreed upon time.

The system and method of the present invention also provides creditors access to the system in order to be able to view all of the creditor's debtors who hold accounts and are enrolled in the system. In conjunction, a creditor can view all outstanding settlement proposals that have been submitted to the creditor through the system and, as a result of this capability, can settle the accounts owed in bulk. All settlement offers or proposals not labeled as current will be placed in a separate data structure (shown as “ClientProposals_Log” 580 in FIG. 4).

In addition, it is contemplated that should a user or client need further assistance and/or legal guidance, the system and method of the present invention will also be capable to connect the user or client with a particular resource that can provide that needed assistance or guidance.

The following description provides an illustrative example of how a hypothetical user or client (referred to herein as “Client X”), having an overdue balance on an account (referred to herein as “Account A”), and a respective creditor of Account A (referred to herein as “Creditor Y”), utilize an exemplary embodiment of the system and method of the present invention to negotiate a settlement and repayment of the outstanding debt on Account A. As described in detail above, the system and method of the present invention uniquely and advantageously allows for a debtor and a creditor to successfully negotiate the settlement of a debt without any direct contact between the debtor and the creditor, or an outside intermediary, by automating a significant part of the negotiation and repayment process whereby the process is transparent and visible to the debtor and creditor.

As depicted in FIGS. 1 and 2, to begin the settlement process, Client X first completes a sign-in or enrollment process 10 using a computer-based software application or platform to obtain secured access to the computerized portal 1 and to input 20 the necessary information about Client X and Account A. For example, on a sign-up form displayed by a user-interface of portal 1 that is visible to Client X, Client X enters 20 information pertaining to Client X's income and personal identification, and the particulars of Account A, such as the outstanding balance owed, the date on which the balance was due, and the identity of the respective creditor (“Creditor Y”) of Account A. Once entered, Client X's data is stored 30 in at least one database that is in communication with the portal, and becomes a customer record 50. The data pertaining to Account A is stored as an accounts record 45, whereby the account record 45 is identified with Client X using a user identifier 40 that is associated with the record.

Following Client X's data input and the creation of the customer record 50, two parallel processes occur to complete the enrollment process 55. In a synchronous process 60, Client X is required to execute 65 a user agreement or contract 61 in, for example, an electronic form (“e-Sign”) 63, that is populated 62 by the data input 20 provided by Client X in the initial sign-up form. Thereafter, a confirmation or acknowledgment letter 64, including a security identification code and password for gaining future access 1020 to the system using the portal 1, is automatically generated and sent to Client X by electronic mail or by other methods.

In an asynchronous process 70 occurring in parallel with the synchronous process 60 described above, a plurality of records 75 are created that serve as the data layer for Client X's system account. Using the credentials received in the confirmation or acknowledgment letter 64, Client X logs in 80 to the system for the first time to complete the enrollment 90. Upon accessing the system for the first time, Client X is able to view and receive a series of documents 72, a savings and payment plan 73, a budget 74, and a user profile 71 that were created during the asynchronous process 70 using the information pertaining to the personal identification of Client X and Client X's financial background, and the information pertaining to Account A and Creditor Y, that was entered into the system by Client X.

Documents 72, which are viewable to Client X upon accessing the system, may include a cease and desist letter that is automatically generated 600 from information about Account A that is extracted from Client X's original sign-up form. The cease and desist letter seeks the delay of the collection of the debt pending negotiation of a settlement and is automatically sent to Creditor Y using electronic correspondence (e.g., by e-mail or e-fax) or by other methods on behalf of Client X.

Once all of Client X's necessary financial and personal information is transferred into the system from the sign-up and enrollment process 10, an automatic scoring process 100 of Account A begins as shown in FIG. 3. Using the input of information from Client X, the system automatically generates a score 150 for Account A. Client X's information may be extracted 110 from the customer record 50 and the account record 45 for Account A and can include, but is not limited to, Client X's account number, social security number, contact information, date of birth, account balance, and account debt type code. Information about Account A can also be extracted and may include, but is not limited to, the last payment date, credit limit, and origination date of Account A. Using a proprietary scoring mechanism, the system analyzes the information pertaining to Account A and generates a score 150 that is used as a factor to determine 200 whether or not Account A is eligible, according to a pre-determined standard, for settlement.

If it is deemed that the parameters of Account A result in it being ineligible for settlement, then another action will be recommended 250 to Client X, such as entering into bankruptcy or payment of the entire debt in full.

However, if Account A is deemed to be eligible for settlement 300, the score 150 is used automatically to create 350 a range of settlement offers, in what may be referred to as a “Debtor Offer Profile,” that will be presented to Creditor Y in an attempt to settle the balance owed on Account A. This “Debtor Offer Profile” 350 is based on Client X's financial and personal information gathered by the system and provides the initial settlement offer amounts that are in accord with Client X's ability to settle and repay the debt.

Based upon the parameters of the “Debtor Offer Profile” 350 and score 150, an initial debt settlement proposal or offer 410 is automatically generated 400 for Account A from Client X's creditor record (or “ClientCR”) 450, using one or more pre-determined algorithms. Thereafter, the initial settlement offer 410 is automatically relayed 420 to Creditor Y using, for example, electronic correspondence (e.g., by e-mail or e-fax) or other methods on behalf of Client X, and enters into a negotiation process 430 as shown in FIG. 4.

In a parallel process to generation 400 of the settlement offer(s) 410, a savings payment plan and budget 73, 74 for Client X is automatically generated 700 based upon the offer amounts proposed in the settlement proposals (see FIGS. 1 and 2). To receive the savings payment plan and budget 73, 74, Client X accesses the system 1020 using portal 1. The savings and payment plan 73 and budget 74 provide a recommended framework for Client X to follow in order to successfully meet the payment requirements of the settlement proposal or offer being presented to Creditor Y in view of Client X's income and other financial considerations. For example, the savings and payment plan 73 and budget 74 may set forth a certain amount of funds that must be set aside and deposited in a specified “savings” or a dedicated escrow account by Client X on a periodic (e.g. monthly) basis in order to make the payments in line with the particular schedule or timeframe that is required by the settlement proposal or offer.

Now, referring back to FIG. 4, the settlement proposal 410 may evolve 430 through different states based upon any back-and-forth negotiations and the resulting decisions made by Creditor Y and the Client X. As this negotiation process is carried out, the system of the present invention intelligently “learns” and records the behavior of Creditor Y and the associated accounts of Creditor Y in order to calibrate 500, from a default profile, a profile that is characteristic of Creditor Y, which may be referred to as a “Creditor Offer Profile” 510. The “Creditor Offer Profile” 510 sets forth a predictable settlement range, based on the past and learned behavior of the creditor, for accounts that are defined by certain characteristics. These characteristics may include, but are not limited to, the account's balance, days past due, original enrollment date, credit limit, and score 150. Thus, the “Creditor Offer Profile” will contain the parameters for which Creditor Y is most likely to accept a settlement offer for a given type of account with an associated score 150. Accordingly, prior to sending 420 any settlement offer to Creditor Y, Client X's creditor record (“ClientCR”) 450 performs a conditional check to determine whether or not the automatically generated initial offer amount 410 is amenable to the “Debtor Offer Profile” 350, the “Creditor Offer Profile” 510, and the current dollar amount held in “savings” or in the dedicated escrow account by Client X.

As shown in FIGS. 4 and 5, to act 550 on the initial settlement offer 410, a security identification code and password is also relayed 530 to Creditor Y so that Creditor Y may gain access to the secured system and method of the present invention through a separate creditor interface or portal 520. Upon accessing the system, Creditor Y can view 552, accept 554, decline 556 or present a counteroffer 558 to any settlement proposal it has received from the system. Once Creditor Y takes an action or makes a decision on a settlement offer or proposal, the state of that particular offer or proposal is updated or changed 570 to reflect Creditor Y's action or decision and is simultaneously visible to Client X. Client X can view all settlement proposals that have been accepted, declined, or countered by Creditor Y (shown as 170 in FIG. 1).

If Creditor Y decides to decline 556 the settlement proposal, the system will automatically generate a new settlement proposal 551 based upon one or more predetermined algorithms whereby the new settlement proposal 551 falls within the range of settlement offers provided by Client X's “Debtor Offer Profile” 350. This new proposal 551 is sent to Creditor Y in order to proceed with the negotiation process. Should Creditor Y submit a counteroffer 558, Client X accesses 1020 the system to view the counteroffer 558 and to determine whether or not to accept 454, reject 456, or submit a separate counteroffer 458 back to Creditor Y. If Client X decides to reject or submit a counteroffer, the system automatically generates a new settlement proposal 451, 452 for Creditor Y's review 552. Again, prior to sending any settlement offer to Creditor Y, Client X's creditor record (“ClientCR”) 450 performs a conditional check to determine whether or not the automatically generated offer is amenable to the “Debtor Offer Profile” 350, the “Creditor Offer Profile” 510, and the current dollar amount held in “savings” or in the dedicated escrow account by Client X. Once Client X takes an action or makes a decision on a settlement offer or proposal, the state of that particular offer or proposal is updated or changed to reflect the user or client's action or decision and is simultaneously visible to the creditor. This back-and-forth negotiation process continues, in an almost entirely automatic manner, until both the Client X and Creditor Y have mutually accepted a particular settlement proposal.

As Creditor Y reviews and acts upon open settlement offers, the “Creditor Offer Profile” 510 will be automatically updated 500 to reflect a present state of knowledge about Creditor Y's behavior and tendencies in taking certain actions on certain types of settlement offers. For example, if a certain type of settlement offer had previously been within the acceptable range of Creditor Y's “Creditor Offer Profile” 510, but since that time, a similar settlement offer has been subsequently rejected by Creditor Y, the “Creditor Offer Profile” will be updated to reflect this change. In this way, the “Creditor Offer Profile” allows the process to intelligently and uniquely identify and craft settlement proposals that are more likely to be accepted by the creditor in comparison to a benchmark settlement offer.

Upon Creditor Y accepting 554 a settlement proposal, the funds that have accumulated in Client X's “savings” or dedicated escrow account will automatically be sent to Creditor Y to satisfy the outstanding debt. The available funds in the “savings” or escrow account are accumulated in such a way that a percentage of all payments being made Client X is automatically placed into this account resulting in the accumulation of funds over time. Client X will have access to view this process as it occurs. Once the one or more payments are made and the debt is satisfied in full, the automated process and the settlement is complete 900.

FIGS. 6 and 7 depict an exemplary process for dispersing the accumulated funds in accordance with the terms 610 of the agreed-upon settlement 900. The terms of the settlement may call for Client X to either pay a settlement amount in the form of a lump sum 620, or, for Client X to pay a term sum 630. In the event of a lump sum payment 620, the escrow account is notified 622 to disburse the funds 624 to the appropriate entity. In the event of a term sum payment 630, it may be necessary to first adjust 632 the offer amounts on any other enrolled accounts of Client X due to the ongoing nature of the term payments. After this adjustment is made, the escrow account is notified 634 to disburse the funds 636 to the appropriate entity.

Lastly, as shown in FIG. 4, to generate revenue for funding the service provided by the system and method of the present invention, the settlement 900 may be made contingent on payment of a service fee to the service provider. The type of fee 810 may be determined 800 once a settlement offer is agreed upon by Client X and Creditor Y. The type of fee accessed may be, for example, based on a percentage of the debt amount of the settled account 820, or of the amount of funds saved by the settlement of the account 830. Once the fee is determined, the system determines 840 whether or not a sufficient amount of funds for payment of the fee exists in Client X's “savings” or escrow account. If there are sufficient funds available 850 for payment of the fee, then the settlement can be completed 900. If there are not sufficient funds available 860 for payment of the fee, a new status, such as a “Settlement Pending Funds” state 870, may occur until the necessary funds are deposited 880 into the escrow account. Consequently, the entire settlement process will reset 1000 and begin anew if the necessary funds are not deposited in the escrow account within an agreed upon time.

The foregoing description and accompanying drawing illustrate the principles, preferred embodiments and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention.

What is claimed is:

1. A system for facilitating a settlement negotiation of a debt between a debtor and a creditor, comprising:
at least one database operable to store user-entered data figures that reflect information about at least one account of which the debtor is in debt;
a computerized portal:
directly accessible to at least one debtor through a debtor user-interface;
directly accessible to at least one creditor through a creditor user-interface; and
being in communication with the at least one database to permit data entry by the debtor of the data figures through the debtor user-interface and storage of the data figures into the at least one database;
a computer system in communicative contact with the at least one database and the portal and programmed to:
generate a score associated with the at least one account and dependent upon the data figures, the score being a criterion to determine if the at least one account is eligible for settlement;
automatically generate an initial settlement offer based at least in part upon the data figures, if the at least one account is eligible for settlement; and
automatically relay the initial settlement offer to the respective creditor of the at least one account;
permit the creditor to access the initial settlement offer, through the creditor user-interface, and directly act upon the initial settlement offer; and
store in the at least one database action information corresponding to action taken by the creditor on the initial settlement offer; and
make the action information directly visible to the debtor when the debtor subsequently accesses the action information through debtor user-interface.

2. The system according to claim 1, wherein access to the portal requires a secure password.

3. The system according to claim 1, wherein the data figures reflect information selected from at least:
a balance owed by the debtor on the at least one account;
a date on which the account was past due;
an identity of the respective creditor of the account; and
an amount of the debtor's income.

4. The system according to claim 1, wherein the computer system is programmed to automatically generate the score after the user-entered data figures are stored in the at least one database.

5. The system according to claim 1, wherein:
the at least one database is operable to store a creditor behavior profile of the at least one creditor; and
the computer system is programmed to generate the creditor behavior profile dependent upon each action taken by the creditor in response to at least the initial settlement offer.

6. The system according to claim 5, wherein the computer system is programmed to:
carry out a debtor-to-creditor communication process that exchanges at least one additional settlement offer after the initial settlement offer;
alter the creditor behavior profile dependent upon each action taken by the creditor in response to at least the initial settlement offer and the at least one additional settlement offer; and
predict an action the creditor will likely take on at least one of at least the initial settlement offer and the at least one additional settlement offer based upon each action taken by the creditor in response to a settlement offer that is similar to at least one of the initial settlement offer and the at least one additional settlement offer.

7. The system according to claim 6, wherein the creditor behavior profile is automatically updated each time the creditor takes an action in response to at least one of the initial settlement offer and the at least one additional settlement offer.

8. The system according to claim 6, wherein the computer system is programmed to base the initial settlement offer at least in part upon the prediction from the creditor behavior profile.

9. The system according to claim 1, wherein the action taken by the creditor is selected from one of:
an acceptance of the initial settlement offer;
a rejection of the initial settlement offer; and
a counter settlement offer to the initial settlement offer.

10. The system according to claim 9, wherein the computer system is programmed to automatically generate a new settlement offer and relay the new settlement offer to the creditor if the creditor rejects the initial settlement offer.

11. The system according to claim 6, wherein:
the at least one database is operable to:
store a user-entered debtor profile comprised of profile information entered by the debtor through the debtor user-interface, the profile information reflecting a financial condition of the debtor and including a range of possible settlement offers based at least in part on the information reflecting the financial condition of the debtor; and
store a creditor behavior profile comprised of each past action taken by the creditor in response to at least one of the initial settlement offer and the at least one additional settlement offer; and
the computer system is programmed to predict what action the creditor will likely take on any given settlement offer based upon each past action taken by the creditor in response to at least one of the initial settlement offer and the at least one additional settlement offer similar to the given settlement offer, the new settlement offer being within the range of possible settlement offers in the debtor profile and dependent at least in part upon at least one of the prediction and the creditor behavior profile.

12. The system according to claim 9, wherein, upon receipt of a counter settlement offer, the computer system is programmed to provide the debtor with a choice selected from one of:
accept the counter settlement offer of the creditor;
reject the counter settlement offer of the creditor; and
counter the counter settlement offer of the creditor.

13. The system according to claim 12, wherein the computer system is programmed to:
permit direct debtor access to the choice of accepting, rejecting, or countering the counter settlement offer;
store in the at least one database the choice of the debtor; and
visibly display the choice to the creditor through the creditor user-interface upon subsequent creditor access of the portal.

14. The system according to claim 12, wherein:
the at least one database is operable to:
store a user-entered debtor profile comprised of profile information entered by the debtor through the debtor user-interface, the profile information reflecting a financial condition of the debtor and including a range of possible settlement offers based at least in part on the information reflecting the financial condition of the debtor; and
store a creditor behavior profile comprised of each action taken by the creditor in response to at least one of the initial settlement offer and the at least one additional settlement offer; and
the computer system is programmed to one of accept, reject, and counter the creditor's counter settlement offer on behalf of the debtor based at least in part on whether or not the counter settlement offer of the creditor is within the range of possible settlement offers.

15. A method for facilitating a settlement negotiation of a debt, which comprises:
directly accessing a computerized portal by at least one debtor using a user-interface, the portal being in communication with at least one database;
inputting into the portal data figures that reflect information about at least one account of which the at least one debtor is in debt;
storing the data figures in the at least one database;
analyzing the data figures to give the at least one account a score;
determining if the at least one account is eligible for settlement using the score as a criterion and, if the account is eligible for settlement:
automatically generating an initial settlement offer based at least in part upon the data figures;
automatically relaying the initial settlement offer to a respective creditor of the at least one account;
acting upon the initial settlement offer by directly accessing the portal by the creditor using the user-interface;
storing the action of the creditor in the at least one database; and
making the creditor's action directly visible to the debtor upon subsequent debtor access of the portal.

16. The method according to claim 15, wherein access to the portal requires a secure password.

17. The method according to claim 15, wherein the data figures reflect at least:
the balance owed by the debtor on the at least one account;
the date on which the account was past due;
the identity of the respective creditor of the account; and
the amount of the debtor's income.

18. The method according to claim 15, wherein the analyzing step to generate the score is carried out automatically after the data figures are stored in the at least one database.

19. The method according to claim 15, which further comprises:
storing a creditor behavior profile in the at least one database, the creditor behavior profile being comprised of each past action taken by the creditor in response to a settlement offer; and
utilizing the creditor behavior profile, predicting what action the creditor will likely take on any given settlement offer based upon each past action taken by the creditor in response to a settlement offer that was similar to the given settlement offer.

20. The method according to claim 19, which further comprises automatically updating the creditor behavior profile each time the creditor takes an action in response to a settlement offer.

21. The method according to claim 19, which further comprises basing the initial settlement offer, at least in part, upon the prediction from the creditor behavior profile.

22. The method according to claim 15, wherein the action of the creditor is one of:
an acceptance of the initial settlement offer;
a rejection of the initial settlement offer; and
a counter settlement offer to the initial settlement offer.

23. The method according to claim 22, which further comprises automatically generating and relaying to the creditor a new settlement offer if the creditor rejects the initial settlement offer.

24. The method according to claim 23, which further comprises:
storing a debtor profile in the at least one database, the debtor profile being comprised of information, entered into the portal by the debtor and stored in the at least one database, that reflects the financial condition of the debtor; and
utilizing the debtor profile to provide a range of possible settlement offers based at least in part on the information reflecting the financial condition of the debtor;
storing a creditor behavior profile in the at least one database, the creditor behavior profile being comprised of each past action taken by the creditor in response to a settlement offer;
utilizing the creditor behavior profile to predict what action the creditor will likely take on any given settlement offer based upon each past action taken by the creditor in response to a settlement offer that was similar to the given settlement offer;
generating the new settlement offer from the range of possible settlement offers; and
basing the new settlement offer, at least in part, upon the prediction from the creditor behavior profile.

25. The method according to claim 22, wherein, if the creditor counters the initial settlement offer, the debtor carries out one of:
accepting the creditor's counter settlement offer;
rejecting the creditor's counter settlement offer; and
countering the creditor's counter settlement offer.

26. The method according to claim 25, which further comprises:
directly accessing the portal by the debtor using the user-interface to take a debtor's action selected from one of accepting, rejecting, and countering the creditor's counter settlement offer; and
storing the debtor's action in the at least one database, the debtor's action being directly visible to the creditor upon the creditor subsequent access of the portal.

27. The method according to claim 26, which further comprises:
storing a debtor profile in the at least one database, the debtor profile being comprised of information, entered into the portal by the debtor and stored in the at least one database, that reflects the financial condition of the debtor; and
utilizing the debtor profile to provide a range of possible settlement offers based at least in part on the information reflecting the financial condition of the debtor; and
one of accepting, rejecting, and countering the counter settlement offer of the creditor based, at least in part, on whether or not the counter settlement offer of the creditor is within the range of possible settlement offers.
